(19) United States
(12) Patent Application Publication
(10) Pub. No.: US 2025/0022374 A1
(43) Pub. Date: Jan. 16, 2025

(54) PROCESSING METHOD, DRIVING SYSTEM, PROCESSING DEVICE, AND PROGRAM PRODUCT THEREOF

(71) Applicant: DENSO CORPORATION, Kariya-city (JP)

(72) Inventors: ATSUSHI BABA, Kariya-city (JP); TETSUYA TODO, Kariya-city (JP); HIROSHI KUWAJIMA, Kariya-city (JP)

(21) Appl. No.: 18/900,280

(22) Filed: Sep. 27, 2024

Related U.S. Application Data
(63) Continuation of application No. PCT/JP2023/010445, filed on Mar. 16, 2023.

(30) Foreign Application Priority Data
Apr. 1, 2022 (JP) 2022-061926

(51) Int. Cl. G08G 1/16; B60W 30/095

(52) U.S. Cl. CPC G08G 1/166; B60W 30/0956; B60W 2554/4045; B60W 2556/10; B60W 2556/45

(57) ABSTRACT

A processing method, which is executed by a processor for performing a processing related to a driving of a host moving object, includes a performance achievement prediction that predicts a future action of an other road user in an external environment of the host moving object as a prediction for achieving a target performance of the host moving object; a driving plan that plans the driving of the host moving object according to the performance achievement prediction; a safety assurance prediction that predicts, independently of the performance achievement prediction, the future action of the other road user in the external environment as a prediction for assuring a reasonably foreseeable safety of the host moving object; and a driving monitoring that monitors the driving of the host moving object according to the safety assurance prediction.

### CROSS REFERENCE TO RELATED APPLICATIONS

The present application is a continuation application of International Patent Application No. PCT/JP2023/010445 filed on Mar. 16, 2023, which designated the U.S. and claims the benefit of priority from Japanese Patent Application No. 2022-61926 filed on Apr. 1, 2022. The entire disclosures of all of the above applications are incorporated herein by reference.

### TECHNICAL FIELD

The present disclosure relates to a technique for performing a processing related to a driving of a host moving object.

### BACKGROUND

There has been known a technique for predicting a motion trajectory of an object, which corresponds to an other road user, with respect to a vehicle, which corresponds to a host moving object, and using the predicted motion trajectory for driving planning and driving monitoring of the vehicle.

### SUMMARY

The present disclosure provides a processing method, which is executed by a processor for performing a processing related to a driving of a host moving object. The processing method includes a performance achievement prediction that predicts a future action of an other road user in an external environment of the host moving object as a prediction for achieving a target performance of the host moving object; a driving plan that plans the driving of the host moving object according to the performance achievement prediction; a safety assurance prediction that predicts, independently of the performance achievement prediction, the future action of the other road user in the external environment as a prediction for assuring a reasonably foreseeable safety of the host moving object; and a driving monitoring that monitors the driving of the host moving object according to the safety assurance prediction.

### BRIEF DESCRIPTION OF DRAWINGS

Objects, features and advantages of the present disclosure will become apparent from the following detailed description made with reference to the accompanying drawings.

FIG. 1 is a block diagram illustrating a physical architecture of a driving system according to a first embodiment.

FIG. 2 is a schematic diagram illustrating a travel environment of a host vehicle to which the first embodiment is applied.

FIG. 3 is a block diagram illustrating a functional architecture of the driving system according to the first embodiment.

FIG. 4 is a schematic diagram describing a performance achievement range and a safety range according to the first embodiment.

FIG. 5 is another schematic diagram describing the performance achievement range and the safety range according to the first embodiment.

FIG. 6 is a flowchart illustrating a processing flow according to the first embodiment.

FIG. 7 is a characteristic table describing a performance achievement prediction and a safety assurance prediction according to the first embodiment.

FIG. 8 is a block diagram illustrating a functional architecture of a driving system according to a second embodiment.

FIG. 9 is a flowchart illustrating a processing flow according to the second embodiment.

FIG. 10 is a block diagram illustrating a functional architecture of a driving system according to a third embodiment.

FIG. 11 is a flowchart illustrating a processing flow according to the third embodiment.

### DETAILED DESCRIPTION

In the above-described known art, the motion trajectory of the object is predicted by a common model that emphasizes safety for both the driving planning and the driving monitoring. Thus, there is a concern that original target performance of the vehicle may be impaired. On the other hand, when the prediction based on the emphasizing of the target performance is executed, there is a concern that an unreasonable risk may be introduced.

According to a first aspect of the present disclosure, a processing method is executed by a processor for performing a processing related to a driving of a host moving object. The processing method includes: a performance achievement prediction that predicts a future action of an other road user in an external environment of the host moving object as a prediction for achieving a target performance of the host moving object; a driving plan that plans the driving of the host moving object according to the performance achievement prediction; a safety assurance prediction that predicts, independently of the performance achievement prediction, the future action of the other road user in the external environment as a prediction for assuring a reasonably foreseeable safety of the host moving object; and a driving monitoring that monitors the driving of the host moving object according to the safety assurance prediction.

According to a second aspect of the present disclosure, a driving system includes a processor performing a processing related to a driving of a host moving object. The processor is configured to execute: a performance achievement prediction that predicts a future action of an other road user in an external environment of the host moving object as a prediction for achieving a target performance of the host moving object; a driving plan that plans the driving of the host moving object according to the performance achievement prediction; a safety assurance prediction that predicts, independently of the performance achievement prediction, the future action of the other road user in the external environment as a prediction for assuring a reasonably foreseeable safety of the host moving object; and a driving monitoring that monitors the driving of the host moving object according to the safety assurance prediction.

According to a third aspect of the present disclosure, a processing device is mounted on a host moving object to perform a processing related to a driving of the host moving object. The processing device includes a processor that is configured to execute: a performance achievement prediction that predicts a future action of an other road user in an external environment of the host moving object as a prediction for achieving a target performance of the host moving object; a driving plan that plans the driving of the host moving object according to the performance achievement prediction; a safety assurance prediction that predicts, independently of the performance achievement prediction, the future action of the other road user in the external environment as a prediction for assuring a reasonably foreseeable safety of the host moving object; and a driving monitoring that monitors the driving of the host moving object according to the safety assurance prediction.

According to a fourth aspect of the present disclosure, a processing program product is stored in a computer-readable non-transitory storage medium and includes instructions to be executed by a processor to perform a processing related to a driving of a host moving object. The instructions causse the processor to execute: a performance achievement prediction that predicts a future action of an other road user in an external environment of the host moving object as a prediction for achieving a target performance of the host moving object; a driving plan that plans the driving of the host moving object according to the performance achievement prediction; a safety assurance prediction that predicts, independently of the performance achievement prediction, the future action of the other road user in the external environment as a prediction for assuring a reasonably foreseeable safety of the host moving object; and a driving monitoring that monitors the driving of the host moving object according to the safety assurance prediction.

According to the host moving object of the first to fourth aspects, the driving plan is executed according to the performance achievement prediction result acquired by predicting the future action of the other road user in the external environment of the host moving object, as the prediction for achieving target performance. Therefore, in the host moving object of the first to fourth aspects, driving monitoring is executed according to the safety assurance prediction obtained by predicting the future action of the other road user independently of the performance achievement prediction, as the prediction for assuring the reasonably foreseeable safety. According to this configuration, driving of the host moving object that is planned according to the performance achievement prediction is monitored according to the safety assurance prediction, so that it becomes possible to achieve a balance between the driving performance and the safety in the driving.

Hereinafter, multiple embodiments of the present disclosure will be described based on the drawings. Duplicate description may be omitted by assigning the same reference numerals to the corresponding configuration elements in each embodiment. When only a part of the configuration is described in each embodiment, the configurations of the other embodiments described above can be applied to the other parts of the configuration. Not only the combinations of the configurations explicitly specified in the description of each embodiment, but also the configurations of the multiple embodiments can be partially combined even if they are not explicitly specified unless there is a particular problem with the combination.

### First Embodiment

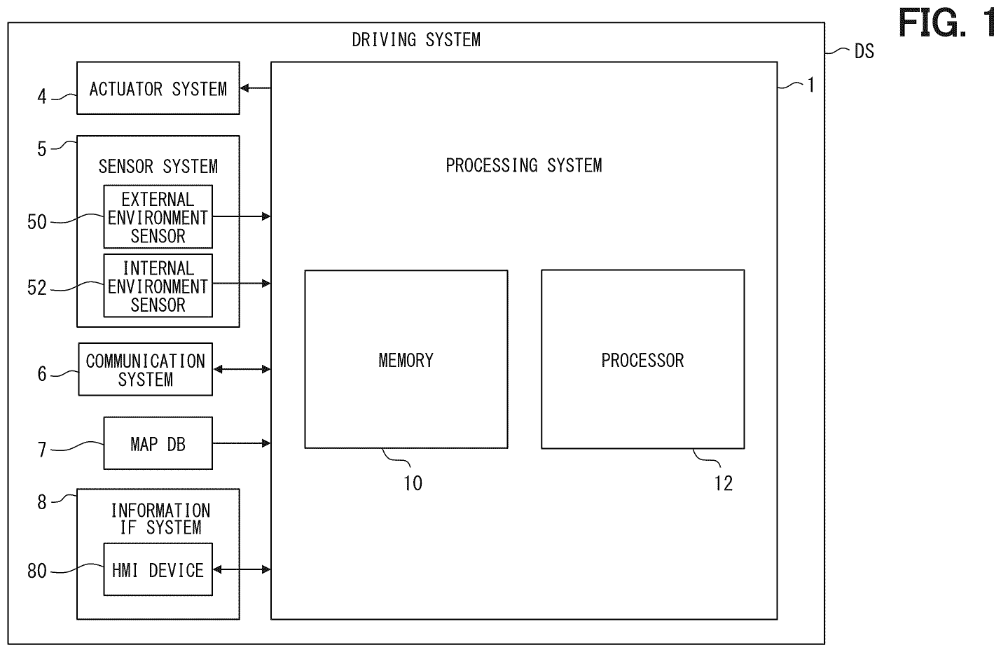

A driving system DS of the first embodiment illustrated in FIG. 1 is configured to include a processing system 1 in order to perform processing related to driving of a host moving object (hereinafter, referred to as a driving process). A part or all of the driving system DS are mounted on the host moving object.

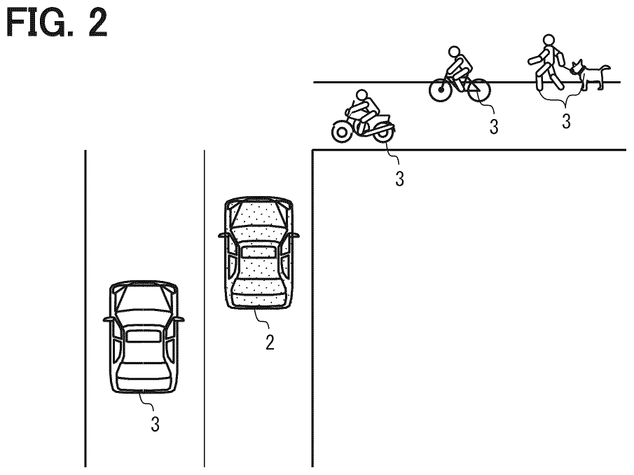

The host moving object as a target for a driving process in the driving system DS is a host vehicle 2 illustrated in FIG. 2. The host vehicle 2 is a road user capable of executing autonomous driving on, for example, a car, a truck, or the like. The host vehicle 2 may be referred to as a subject vehicle (ego-vehicle). Driving in the host vehicle 2 is divided into levels according to a range of a task performed by a driver who is an occupant in a driver's seat, among all dynamic driving tasks (DDTs). Here, the driver who can perform the DDT by a manual operation on the host vehicle 2 according to the levels of driving automation is a vehicle operator, and can also be said to be a vehicle user.

The levels of driving automation are defined by, for example, SAE J3016. Specifically, at levels 0 to 2, the driver performs a part or all of the DDT. Levels 0 to 2 may be classified as so-called manual driving. Level 0 indicates that driving is not automated. Level 1 indicates that the driving system DS supports the driver. Level 2 indicates that driving is partially automated. At level 3 or higher, while the driving system DS is engaged, the driving system DS performs the entire DDT. Levels 3 to 5 may be classified as so-called autonomous driving. The driving system DS capable of executing driving at level 3 or higher may be referred to as an automated driving system. Level 3 indicates that driving is conditionally automated. Level 4 indicates that driving is highly automated. Level 5 indicates that driving is fully automated. The driving system DS that cannot execute driving at level 3 or higher and can execute driving at at least one of levels 1 and 2 may be referred to as a driving support system. In the following description, it is assumed that an automated driving system or a driving support system is included in the driving system DS unless there is a circumstance that specifies the maximum achievable levels of driving automation.

An other road user 3 with respect to the host vehicle 2 is a road user other than the host vehicle 2, who exists in an external environment in which the host vehicle 2 travels. The other road user 3 includes, for example, non-vulnerable road users such as cars, trucks, motorcycles, and bicycles, and vulnerable road users such as pedestrians. The other road user 3 may further include animals.

In a physical architecture illustrated in FIG. 1, the driving system DS includes an actuator system 4, a sensor system 5, a communication system 6, a map database (DB) 7, an information interface (IF) system 8, and the processing system 1, as physical components. Meanwhile, the driving system DS may include at least the processing system 1 as its own physical components, and at least one type of physical components belonging to the actuator system 4, the sensor system 5, the communication system 6, the map DB 7, and the information IF system 8 may be replaced by a physical component belonging to the host vehicle 2.

The actuator system 4 is configured to be able to control driving of the host vehicle 2 based on an input control signal. The actuator system 4 may be at least one type of power train actuator of, for example, an internal combustion engine, a motor generator motor, and the like. The actuator system 4 may be at least one type of brake actuator of, for example, a brake unit and the like. The actuator system 4 may be at least one type of steering actuator of, for example, a power steering unit and the like.

The sensor system 5 acquires sensor data which is usable by the driving system DS by detecting an external environment and an internal environment of the host vehicle 2. For this purpose, the sensor system 5 includes an external environment sensor 50 and an internal environment sensor 52.

The external environment sensor 50 may detect a target object existing in the external environment of the host vehicle 2. The external environment sensor 50 having a target object detection type is at least one type of, for example, a camera, a light detection and ranging/laser imaging detection and ranging (LiDAR), a laser radar, a millimeter wave radar, an ultrasonic sonar, and the like. The external environment sensor 50 having the target object detection type is typically implemented in a combination of multiple types, for capable of sensing the host vehicle 2 in each direction of front, side, and rear. The external environment sensor 50 may detect an atmospheric condition in the external environment of the host vehicle 2. The external environment sensor 50 having an atmospheric detection type is at least one type of, for example, an outside air temperature sensor, a humidity sensor, and the like.

The internal environment sensor 52 may detect a specific physical quantity related to vehicle motion (hereinafter, referred to as a kinematic property) in the internal environment of the host vehicle 2. The internal environment sensor 52 having a kinematic property detection type is at least one type of, for example, a speed sensor, an acceleration sensor, a gyro sensor, and the like. The internal environment sensor 52 may detect a state of an occupant in the internal environment of the host vehicle 2. The internal environment sensor 52 having an occupant detection type is at least one type of, for example, an actuator sensor, a driver status monitor (registered trademark), a biological sensor, a seating sensor, an in-vehicle device sensor, and the like. Here, examples of the actuator sensor include at least one type of, for example, a starting switch, an accelerator sensor, a brake sensor, a steering sensor, and the like, which detects an operating state of an occupant regarding the actuator system 4 of the host vehicle 2.

The communication system 6 acquires communication data that can be used in the driving system DS by wireless communication. The communication system 6 may receive a positioning signal from an artificial satellite of a global navigation satellite system (GNSS) existing in the external environment of the host vehicle 2. The communication system 6 having a positioning type is, for example, a GNSS receiver or the like. The communication system 6 may transmit and receive communication signals to and from a V2X system existing in the external environment of the host vehicle 2. The communication system 6 having a V2X communication type is at least one type of, for example, a dedicated short range communications (DSRC) communication device, a cellular V2X (C-V2X) communication device, and the like. Here, examples of the V2X communication include at least one type of communication with a communication system of an other vehicle that is the other road user 3 (V2V), communication with infrastructure equipment such as a communication device installed at a traffic light (V2I), communication with a mobile terminal of a pedestrian who is the other road user 3 (V2P), communication with a cloud network or mesh network (V2N), and the like. The communication system 6 may transmit and receive communication signals to and from a mobile terminal existing in the internal environment of the host vehicle 2. The communication system 6 having a terminal communication type is at least one type of, for example, Bluetooth (registered trademark) device, Wi-Fi (registered trademark) device, infrared communication device, and the like.

The map DB 7 stores map data that can be used by the driving system DS. The map DB 7 includes at least one type of non-transitory tangible storage medium of, for example, a semiconductor memory, a magnetic medium, an optical medium, and the like. The map DB 7 may be a DB of a locator for estimating a self-state amount of the host vehicle 2 including its own position. The map DB may be a DB of a navigation unit that navigates a travel path of the host vehicle 2. The map DB 7 may be constructed by a combination of multiple types of DBs.

The map DB 7 acquires and stores the latest map data through, for example, V2X communication with an external center via the communication system 6. The map data is two-dimensional or three-dimensional data as data representing a travel environment of the host vehicle 2. Digital data of a high definition map may be adopted as the three-dimensional map data. The map data may include road data representing at least one type of, for example, a positional coordinate, a shape, a road surface condition, and the like of a road structure. The map data may include marking data representing at least one type of, for example, a traffic sign, a road display, a positional coordinate and a shape of a lane marking, and the like attached to a road. The marking data included in the map data may represent, for example, a traffic-control sign, an arrow marking, a lane marking, a stop line, a direction sign, a landmarking beacon, a rectangular sign, a business sign, a line pattern change of a road, and the like among landmarks. The map data may include structure data representing at least one type of positional coordinates, a shape, and the like of a building and a traffic light facing the road, for example. The marking data included in the map data may represent landmarks such as a street light, an edge of a road, a reflecting plate, a pole, or a back side of a traffic sign, for example.

The information IF system 8 mediates transmission of notification information related to a driving process between an occupant including a driver of the host vehicle 2, and the driving system DS. For this purpose, the information IF system 8 includes a human machine interface (HMI) device 80.

The HMI device 80 may be configured to be able to detect an operation for inputting an intention of the occupant in the host vehicle 2 to the driving system DS. The HMI device 80 having an operation detection type is at least one type of, for example, push switch, lever switch, touch panel, and the like. The HMI device 80 having the operation detection type may be replaced by an actuator sensor or the like as the internal environment sensor 52 of the sensor system 5. The HMI device 80 may be configured to be able to detect a gesture for inputting an intention of the occupant in the host vehicle 2 to the driving system DS. The HMI device 80 having a gesture detection type may be replaced by a driver status monitor or the like as the internal environment sensor 52 of the sensor system 5.

The HMI device 80 may present notification information by stimulating a visual sense of the occupant in the host vehicle 2. The HMI device 80 having a visual information presentation type is at least one type of, for example, a head-up display (HUD), a center information display (CID), a multi function display (MFD), a combination meter, a navigation unit, an illumination unit, and the like. The HMI device 80 may present notification information by stimulating an auditory sense of the occupant. The HMI device 80 having an auditory information presentation type is at least one type of, for example, a speaker, a buzzer, a vibration unit, and the like. The HMI device 80 may present notification information by stimulating a skin sensation of the occupant. The HMI device 80 having a skin sensory information presentation type is at least one type of, for example, a steering wheel vibration unit, a vibration unit of a driver's seat, a steering wheel reaction force unit, an accelerator pedal reaction force unit, a brake pedal reaction force unit, and an air conditioning unit.

The processing system 1 is connected to the actuator system 4, the sensor system 5, the communication system 6, the map DB 7, and the information IF system 8 via at least one type of, for example, a local area network (LAN), a wire harness, an internal bus, a wireless communication line, and the like. The processing system 1 includes at least one dedicated computer.

The dedicated computer constituting the processing system 1 may be an integrated electronic control unit (integrated ECU) that integrates driving control of the host vehicle 2. The dedicated computer constituting the processing system 1 may be a detection ECU that processes sensor data detected in the driving control of the host vehicle 2. The dedicated computer constituting the processing system 1 may be a perception ECU that performs perception on the driving control of the host vehicle 2. The dedicated computer constituting the processing system 1 may be a determination ECU or a planning ECU that determines and plans the DDT in the driving control of the host vehicle 2. The dedicated computer constituting the processing system 1 may be a monitoring ECU that monitors the driving control of the host vehicle 2. The dedicated computer constituting the processing system 1 may be an evaluation ECU that evaluates the driving control of the host vehicle 2.

The dedicated computer constituting the processing system 1 may be a navigation ECU that navigates a travel path of the host vehicle 2. The dedicated computer constituting the processing system 1 may be a locator ECU that estimates a self-state amount including a self-position of the host vehicle 2. The dedicated computer constituting the driving system DS may be an actuator ECU that controls the actuator system 4. The dedicated computer constituting the processing system 1 may be an HMI control unit (HCU) that controls the HMI device 80. The dedicated computer constituting the processing system 1 may be a storage ECU that controls storing of data. The dedicated computer constituting the processing system 1 may be at least one external computer that constructs an external center or a mobile terminal which is communicable via, for example, the communication system 6.

The dedicated computer constituting the processing system 1 includes at least one memory 10 and at least one processor 12. The memory 10 is at least one type of non-transitory tangible storage medium of, for example, a semiconductor memory, a magnetic medium, and an optical medium, for non-transitory storage of computer readable programs, data, and the like. The processor 12 includes, as a core, at least one type of, for example, a central processing unit (CPU), a graphics processing unit (GPU), a reduced instruction set computer (RISC)-CPU, and the like.

The memory 10 may be an accumulation device that selects and accumulates at least one type of data and information processed in the driving system DS. The memory 10 may be a volatile storage medium such as, for example, a random access memory (RAM) that temporarily stores at least one type of data and information processed in the driving system DS. The memory 10 may be a database for executing the DDT in the driving system DS.

The memory 10 may be mounted on a substrate in a non-removable and non-replaceable manner, and such a configuration includes an embedded multi media card (eMMC) using a flash memory, for example. The memory 10 may be configured to be removable and replaceable, and such a configuration includes, for example, an SD card. The memory 10 may be implemented as a dedicated computer that constitutes the processing system 1 by a system on a chip (SoC) that is integrated into one chip along with the processor 12 and an input and output IF.

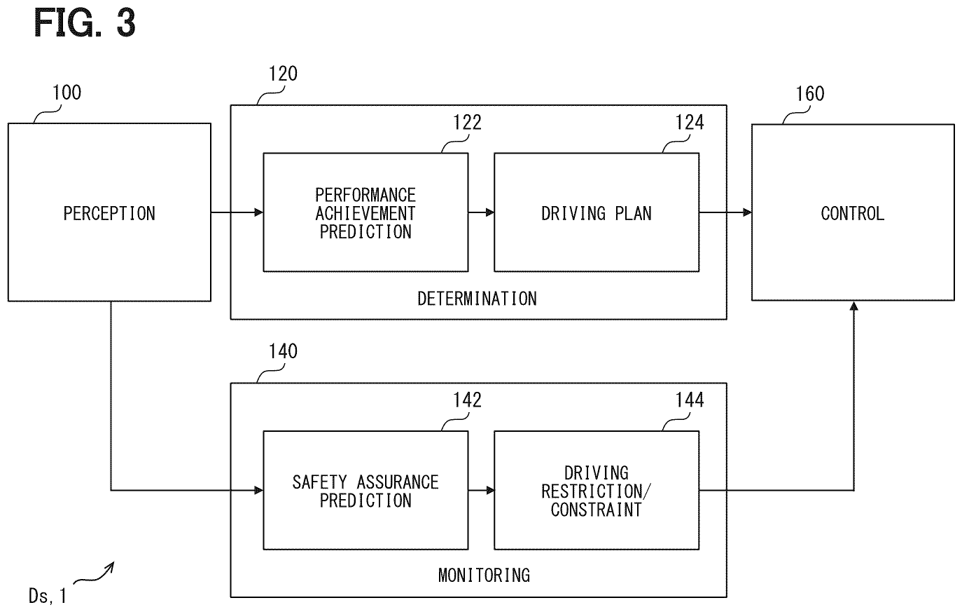

The processor 12 executes multiple instructions included in a processing program stored in the memory 10 as software. Accordingly, the driving system DS including the processing system 1 constructs multiple functional blocks for performing a driving process of the host vehicle 2. In this manner, in the driving system DS, in order to perform a driving process for the host vehicle 2 with the processing system 1 as a main body, the processing program stored in the memory 10 causes the processor 12 to execute the multiple instructions, so that the multiple functional blocks are constructed. The multiple functional blocks thus constructed in the driving system DS include a perception block 100, a determination block 120, a monitoring block 140, and a control block 160, which are illustrated as a functional architecture in FIG. 3.

The perception block 100 acquires sensor data from the sensor system 5. The perception block 100 acquires communication data from the communication system 6. The perception block 100 acquires map data from the map DB 7. The perception block 100 perceives internal and external environments of the host vehicle 2 by individually processing and then fusing these pieces of acquired data.

In generating of perception information, the perception block 100 acquires data from the sensor system 5, the communication system 6, and the map DB 7, understands a meaning of the acquired data, and perceives the internal and external environments including the external environment of the host vehicle 2 and a situation in which the host vehicle 2 is placed under the external environment, and the internal environment of the host vehicle 2, by the fusion of the acquired data. By perceiving the internal and external environments, the perception block 100 generates perception information to be provided to the subsequent determination block 120 and monitoring block 140. The perception block 100 may provide substantially the same perception information to the determination block 120 and the monitoring block 140. The perception block 100 may provide different types of perception information to the determination block 120 and the monitoring block 140.

The perception information generated by the perception block 100 describes a state detected for each scene in the travel environment of the host vehicle 2. The perception block 100 may generate perception information on an object including the other road user 3, an obstacle, and a structure in the external environment of the host vehicle 2, by detecting the object. The perception information on the object may represent at least one type of, for example, a separation distance, a movement direction, a relative speed, a relative acceleration, a size, an estimated state based on tracking detection, and the like. The perception information on the object may represent a classification of the object, which is perceived based on a state of the object clustered by, for example, semantic segmentation. By detecting a traveling path for current and future traveling of the host vehicle 2, the perception block 100 may generate perception information on the traveling path. The perception information on the traveling path may represent at least one type of static structure, among, for example, a road surface, a lane, a road edge, a free space, and the like.

By localization of presumptively perceiving a self-state amount including a self-position of the host vehicle 2, the perception block 100 may generate perception information on the self-state amount. The perception block 100 may generate update data of map data regarding a traveling path of the host vehicle 2 at the same time as the perception information on the self-state amount, and may feedback the update data to the map DB 7. By detecting a marking associated with the traveling path of the host vehicle 2, the perception block 100 may generate perception information on the marking. The perception information on the marking may represent a state of at least one type of, for example, a sign, a lane marking, a traffic light, and the like. The perception information on the marking may further represent a traffic rule perceived or specified from the state of the marking. By detecting a weather situation for each scene in which the host vehicle 2 is traveling, the perception block 100 may generate perception information on the weather situation. By detecting a time for each scene in which the host vehicle 2 is traveling, the perception block 100 may generate perception information on the time.

The determination block 120 acquires perception information from the perception block 100. The determination block 120 may acquire past driving control information from the control block 160 which is a subsequent stage. The determination block 120 may acquire safety assurance information, which will be described below, from the monitoring block 140. The determination block 120 includes a performance achievement prediction block 122 and a driving planning block 124, as sub-functional blocks for planning the driving of the host vehicle 2 according to a prediction based on the acquired information.

The performance achievement prediction block 122 predicts a future action of the other road user 3 in the external environment of the host vehicle 2 in time series. At this time, the performance achievement prediction block 122 performs a performance achievement prediction regarding the future action of the other road user 3 as a prediction for achieving a target performance in the host vehicle 2 through the subsequent driving planning block 124. The future action obtained by the performance achievement prediction may include a risky action of the other road user 3 of which a potential risk with the host vehicle 2 can be predicted. The future action obtained by the performance achievement prediction may be a future trajectory of the other road user 3. Here, the future trajectory may be obtained by the performance achievement prediction such that at least one type of kinematic property regarding the other road user 3 among, for example, a position, a speed, an acceleration, a yaw rate, a movement direction, and the like is defined in time series.

In order to execute such performance achievement prediction, the performance achievement prediction block 122 may be constructed with at least one type of a dedicated computer mounted on the host vehicle 2 and a dedicated computer outside the host vehicle 2. The performance achievement prediction block 122 is constructed by a dedicated computer that is physically common with the driving planning block 124, and may be constructed by a dedicated computer that is physically separate from the driving planning block 124. The performance achievement prediction block 122 is constructed by a dedicated computer that is physically separate from the perception block 100, and may be constructed by a dedicated computer that is physically common to the perception block 100.

The performance achievement prediction block 122 may interpret a travel environment, which is a situation in which the host vehicle 2 is placed, as a basic process for performing a performance achievement prediction. At this time, the performance achievement prediction block 122 may interpret an intention and an action based on classification of the other road user 3 who is a dynamic object, or may interpret a driving situation that can be classified. Here, the interpretation on the intention and the action of the other road user 3 may be an interpretation of an action probability based on the intention of the other road user 3, such as a probability of changing lanes, for example. The interpretation on the driving situation may be, for example, an interpretation on traffic rules, traffic congestion situation, and the like. At least a part of the environment interpretation that forms the basis of such performance achievement prediction may be executed by the perception block 100, and an interpretation result as perception information may be provided to the performance achievement prediction block 122.

The performance achievement prediction block 122 may perform a performance achievement prediction, by using a statistical model obtained by modeling a positive risk balance based on risk-benefit evaluation in a social traffic environment (hereinafter, a positive risk balance statistical model is particularly referred to as a risk balance model). In order to avoid a risk of an unreasonable other-responsibility (that is, potential accident responsibility of the other road user 3), the risk balance model may be designed based on, for example, statistical data representing the degree of contribution and/or a probability distribution of actions that can reduce an accident risk, and a social requirement such as a traffic rule. The risk balance model may be designed as an action model of the road user, which is unique to each location in a traffic environment at which the road user can travel. Such a risk balance model may be constructed in a form of at least one type of, for example, a mathematical model obtained by formulating the social requirement and a computer program that executes a process according to the mathematical model. Therefore, parameters of the risk balance model may be tuned based on past driving control information by the control block 160.

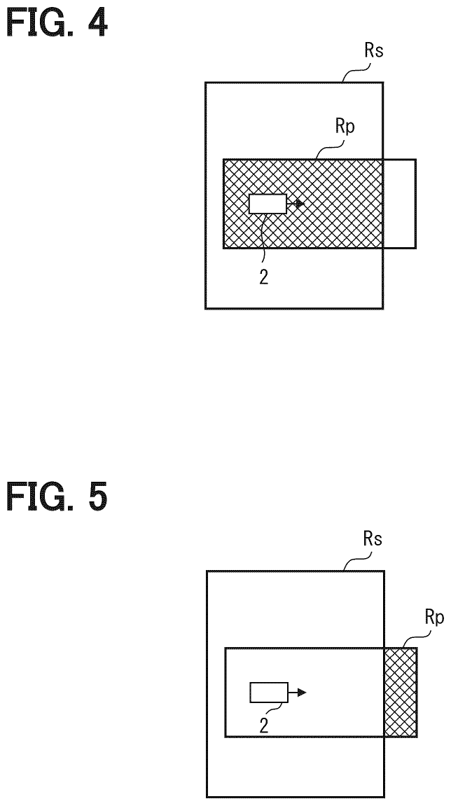

The performance achievement prediction block 122 sets a range Rp of a future action (hereinafter referred to as performance achievement range) for achieving a target performance in the host vehicle 2, based on prediction information acquired as a result of the performance achievement prediction, as illustrated in the example in FIG. 4 and FIG. 5. In other words, the performance achievement prediction can be said to be a future action prediction regarding the other road user 3 for setting the performance achievement range Rp to provide a vehicle motion necessary to achieve the target performance. Accordingly, the performance achievement prediction block 122 illustrated in FIG. 3 may select an important target performance for each scene in which the performance achievement range Rp is set according to the prediction information based on the performance achievement prediction, among multiple performances related to the host vehicle 2. In the performance achievement prediction block 122, a single specific performance regarding the host vehicle 2 may be fixed as a target performance.

The target performance that is a setting target of the performance achievement range Rp may be a safety performance, which is statistically and socially determined to be safe for the host vehicle 2. Here, the safety performance may be determined based on the risk balance model used for the performance achievement prediction.

The target performance that is a setting target of the performance achievement range Rp may be a fuel efficiency performance, which is determined according to an energy saving performance expected of the host vehicle 2. Here, the fuel efficiency performance may be defined as a concept including electricity efficiency performance. The fuel efficiency performance may be determined by using a statistical model by modeling based on, for example, social evaluation data or the like of actual fuel efficiency.

The target performance that is a setting target of the performance achievement range Rp may be a safety performance required of the host vehicle 2, such as at least one type of, for example, an occupant ride comfort performance, a vibration damping performance in a service vehicle, and the like. Here, the safety performance may be determined by using a statistical model by modeling based on, for example, social market research data or the like.

The target performance that is a setting target of the performance achievement range Rp may be a service performance required of the host vehicle 2, such as at least one type of, for example, a relaxation performance in a tourism service vehicle, an express delivery performance in a delivery service vehicle, and the like. Here, the service performance may be determined by using, for example, a statistical model by modeling based on accumulated data for each servicer that socially operates the service vehicle.

The performance achievement prediction block 122 sets the performance achievement range Rp regarding such target performance. As the performance achievement range Rp, an allowable range of a kinematic property for giving the host vehicle 2 the vehicle motion necessary to achieve the target performance may be set, based on the risk balance model or the statistical model used to select the target performance. Here, the kinematic property that defines the allowable range which is the performance achievement range Rp is at least one type which is a basis of a driving plan in the driving planning block 124 at the subsequent stage among, for example, a speed, an acceleration, and a posture angle of the host vehicle 2, a separation distance from the other road user 3, and the like (FIG. 4 and FIG. 5 are examples of the acceleration). The setting of such performance achievement range Rp may be performed by the driving planning block 124 prior to a driving plan which will be described below.

The performance achievement prediction block 122 may output at least one type of the prediction information acquired as described above and the setting information of the set performance achievement range Rp to the memory 10 as performance achievement information. The memory 10 to which the performance achievement information is output may be mounted in the host vehicle 2, or may be installed, for example, at an external center or the like outside the host vehicle 2, depending on a type of dedicated computer constituting the driving system DS. The output performance achievement information may be temporarily stored in the memory 10, and provided to the driving planning block 124. The output performance achievement information may be accumulated in the memory 10 by storing as evidence information. The output performance achievement information may be read from the memory 10, which serves as a temporary storage location or an accumulation location as the evidence information, and may be transmitted via the communication system 6 to, for example, an external center or the like outside the host vehicle 2.

The performance achievement information serving as the evidence information may be accumulated in an unencrypted state, or may be accumulated in an encrypted or hashed state. The performance achievement information serving as the evidence information may be accumulated in the memory 10 in association with behavior information representing an actual behavior of the host vehicle 2 as past driving control information by the control block 160. The performance achievement information accumulated in this manner may be used as a lagging measure in training of a risk balance model, which is a predictive model for the performance achievement prediction, or may be used as a leading measure in verification and validation of the risk balance model.

The driving planning block 124 plans driving for the host vehicle 2 according to the performance achievement prediction made by the performance achievement prediction block 122 and the performance achievement range Rp. Therefore, the driving planning block 124 performs a driving plan based on the performance achievement information provided from the performance achievement prediction block 122.

The driving planning block 124 plans a route for the host vehicle 2 to travel in the future by driving control. That is, the driving planning block 124 implements a DDT function of planning a route as a strategic function of the host vehicle 2. The driving planning block 124 may plan at least one type of a route and a lane to a destination based on perception information for estimating a self-position of the host vehicle 2. At this time, the driving planning block 124 may plan at least one type of a lane change request and a deceleration request based on the planned lane.

The driving planning block 124 plans a future behavior of the host vehicle 2, based on the planned route and lane as well as the performance achievement information provided by the performance achievement prediction block 122. That is, the driving planning block 124 implements a DDT function of planning a tactical behavior of the host vehicle 2. The behavior planning function of the driving planning block 124 may include a function of generating a transition condition regarding a state transition of the host vehicle 2. The transition condition regarding the state transition of the host vehicle 2 may correspond to a triggering condition. Therefore, the behavior planning function may include a function of determining the state transition of an application of implementing the DDT, and further the state transition of the driving action, based on the generated transition condition.

The driving planning block 124 plans a future trajectory to be given to the host vehicle 2 along the planned route based on the performance achievement information provided by the performance achievement prediction block 122. That is, the driving planning block 124 implements a DDT function of planning a future trajectory for the host vehicle 2 to travel as a path plan. The future trajectory planned by the driving planning block 124 may define at least one type of a kinematic property regarding the host vehicle 2 of, for example, a position, a speed, an acceleration, a yaw rate, a movement direction, and the like, in time series. The defined time series trajectory plan may construct a scenario for a future travel by navigating of the host vehicle 2. Therefore, the trajectory plan may include a function of selecting or switching an optimum path plan among multiple path plans.

The driving planning block 124 may determine a transition of a driving mode according to the driver's intention based on at least one type of, for example, intention estimation information and biometric information as perception information regarding the driver by the perception block 100. The driving planning block 124 may determine whether the driver has a failure based on at least one type of, for example, intention estimation information and biometric information as the perception information regarding the driver by the perception block 100. The driving planning block 124 may determine whether there is a failure in each of the physical components 1 and 4 to 8 by monitoring the driving system DS.

The driving planning block 124 may plan adjustment of the levels of driving automation in the host vehicle 2, based on at least one type of the performance achievement information obtained by the performance achievement prediction block 122, the driving mode transition determination result, the driver failure determination result, the failure determination result of the driving system DS, the future route planning result, the future behavior planning result, the future trajectory planning result, and the like. The adjustment of the levels of driving automation may include a takeover/handover of the DDT between the driving system DS and the driver, by the transition of the driving mode between autonomous driving and manual driving.

The takeover/handover between the autonomous driving and the manual driving may be implemented by setting an operational design domain (ODD) in which autonomous driving is executed, in a scenario accompanying entry into or exit from the ODD. For example, in an exit scenario from ODD, that is, a takeover/handover scenario from the autonomous driving to the manual driving, an unreasonable situation in which it is determined that an unreasonable risk exists can be cited as a use case. In this use case, the driving planning block 124 may plan a DDT fallback for the driver who becomes a fallback ready user to transit the host vehicle 2 to a minimal risk condition (MRC) by the manual driving.

The adjustment of the levels of driving automation planned by the driving planning block 124 may include degeneracy driving of the host vehicle 2. In a scenario of the degeneracy driving, a use case is an unreasonable situation in which it is determined that an unreasonable risk exists in takeover/handover to manual driving. In this use case, the driving planning block 124 may plan a best effort to transition the host vehicle 2 to the MRC by autonomous driving and autonomous stopping to minimize a harm or a risk of an accident. In addition to the adjustment of lowering the levels of driving automation, in such best efforts, an emergency manoeuvre/emergency operation may be planned, such as DDT fallback or minimum risk manoeuvre (MRM) to reach the MRC as a safe state, for example, as adjustment of maintaining the levels of driving automation. At this time, a notification accompanying the emergency operation may be planned, for example, by the information IF system 8 or the like to make the transition to the MRC more conspicuous both inside and outside the host vehicle 2.

The driving planning block 124 further plans driving control of the host vehicle 2 according to at least the route plan, the behavior plan, the trajectory plan, and the driving level plan, among the plans described above. In the driving control planning, a control command regarding a navigation operation of the host vehicle 2 and a support operation of the driver is generated as a control action. That is, the driving planning block 124 implements a DDT function of planning a motion control request of the host vehicle 2. The control command generated by the driving planning block 124 may include a control parameter for controlling the actuator system 4. Such control planning may be performed by the control block 160, prior to driving control which will be described below.

The monitoring block 140 acquires the perception information from the perception block 100. The monitoring block 140 may acquire past driving control information from the control block 160 that is a subsequent stage. The monitoring block 140 monitors the driving of the host vehicle 2 according to the prediction based on the acquired information, and includes a safety assurance prediction block 142 and a driving restriction/constraint block 144, as sub-functional blocks for setting a restriction/constraint on the driving.

The safety assurance prediction block 142 predicts a future action of the other road user 3 in the external environment of the host vehicle 2 in time series. At this time, the safety assurance prediction block 142 performs a safety assurance prediction regarding the future action of the other road user 3, as a prediction for assuring a reasonably foreseeable safety in the host vehicle 2 through the subsequent driving restriction/constraint block 144. The future action obtained by the safety assurance prediction may include a risky action in which a potential risk with the host vehicle 2 can be predicted. The future action obtained by the safety assurance prediction may be a future trajectory of the other road user 3. Here, the future trajectory may be obtained by the safety assurance prediction such that at least one type of kinematic property regarding the other road user 3 among, for example, a position, a speed, an acceleration, a yaw rate, a movement direction, and the like is defined in time series. The safety assurance prediction in this manner by the safety assurance prediction block 142 may be a prediction for the near future rather than the performance achievement prediction by the performance achievement prediction block 122. In other words, the performance achievement prediction made by the performance achievement prediction block 122 may be a prediction that precedes the safety assurance prediction made by the safety assurance prediction block 142 in a time axis.

The safety assurance prediction block 142 for implementing such safety assurance prediction may be constructed by at least one type of dedicated computer mounted in the host vehicle 2. The safety assurance prediction block 142 is constructed by the dedicated computer physically common to the driving restriction/constraint block 144, and may be constructed by a dedicated computer physically separated from the driving restriction/constraint block 144. The safety assurance prediction block 142 is constructed by a dedicated computer that is physically separate from the perception block 100, and may be constructed by a dedicated computer that is physically common to the perception block 100.

The safety assurance prediction block 142 is constructed by a dedicated computer that is physically separate from the performance achievement prediction block 122, and may be constructed by a dedicated computer that is physically common to the performance achievement prediction block 122. Here, when each of the prediction blocks 142 and 122 is constructed by separate dedicated computers, the safety assurance prediction by the safety assurance prediction block 142 may be physically independent from the performance achievement prediction by the performance achievement prediction block 122. On the other hand, when each of the prediction blocks 142 and 122 is constructed by a common dedicated computer, the safety assurance prediction by the safety assurance prediction block 142 may be functionally independent on software from the performance achievement prediction by the performance achievement prediction block 122. In either case, the fact that the safety assurance prediction is independent from the performance achievement prediction means that the prediction information from the performance achievement prediction is not substantially used for the safety assurance prediction.

Meanwhile, when each of the prediction blocks 142 and 122 is constructed by the separate dedicated computers, the performance achievement prediction by the performance achievement prediction block 122 may be physically independent from the safety assurance prediction by the safety assurance prediction block 142 or prediction information based on the safety assurance prediction may be physically transmitted between the dedicated computers and used. On the other hand, when each of the prediction blocks 142 and 122 is constructed by a common dedicated computer, the performance achievement prediction by the performance achievement prediction block 122 may be made functionally independent from the safety assurance prediction by the safety assurance prediction block 142 or prediction information based on the safety assurance prediction may be used functionally.

The safety assurance prediction block 142 may interpret a travel environment, which is a situation in which the host vehicle 2 is placed, as a basic process for performing safety assurance prediction. At this time, the environment interpretation by the safety assurance prediction block 142 may be implemented in accordance with environment interpretation by the performance achievement prediction block 122. The environment interpretation by the safety assurance prediction block 142 may be implemented independently from the environment interpretation by the performance achievement prediction block 122. For example, in a scene in which a lane structure such as a lane exists, a situation in which a risk of rear-end collision or head-on collision is potentially assumed in a longitudinal direction, and a situation in which a risk of a side-surface collision is potentially assumed in a lateral direction may be interpreted. In environment interpretations in the longitudinal direction and the lateral direction, the state amount regarding the host vehicle 2 and the other road user 3 may be converted to a coordinate system assuming a straight lane. On the other hand, in a scene in which no lane structure exists, a situation in which a risk of track collision is potentially assumed in any direction of the host vehicle 2 may be interpreted.

By the perception block 100 executing at least a part of the environment interpretation that is the basis of such safety assurance prediction, an interpretation result as the perception information may be provided to the safety assurance prediction block 142. In this case, by the perception block 100 executing at least a part of the environment interpretation that is the basis of the performance achievement prediction, a common interpretation result also may be provided to each of the safety assurance prediction block 142 and the performance achievement prediction block 122.

By using a safety model described according to a driving policy and its safety, the safety assurance prediction block 142 may perform safety assurance prediction in accordance with the driving policy. Here, the driving policy following the safety model is defined based on a vehicle level SOTIF strategy (VLSS) that assures a safety of the intended functionality (SOTIF). In other words, the safety model is described by following the driving policy that is implementation of the VLSS and by modeling the SOTIF. The safety model may then be designed to avoid a potential accident responsibility due to an unreasonable risk or a misuse by road users in accordance with rules of accident responsibility. For example, the safety model may be a responsibility sensitive safety model that complies with rules of accident responsibility according to the driving policy.

The safety model may be defined as a safety-related model itself that expresses safety-related aspects of action probabilities based on assumptions on a reasonably foreseeable action of the other road user 3, or may be defined as a model that constitutes a part of the safety-related model. Such a safety model may be constructed in a form of at least one type of, for example, a mathematical model obtained by formulating a vehicle level safety, a computer program for executing a process according to the mathematical model, and the like. Therefore, the safety model may have its parameters tuned by training using a machine learning algorithm such as DNN, for example, which back-propagates past driving control information by the control block 160 to the safety model.

The safety assurance prediction block 142 may assume a reasonably foreseeable safety range Rs between the host vehicle 2 and the other road user 3 as illustrated in FIG. 4 and FIG. 5, as a future action prediction of the other road user 3 based on the safety model. At this time, the safety assurance prediction block 142 may assume the safety range Rs for avoiding a risk of an unreasonable self-responsibility (that is, potential accident responsibility of the host vehicle 2) based on a safety model that complies with rules of accident responsibility. Here, the safety range Rs may be defined as a boundary in which an unreasonable risk is predicted to occur if a performance limitation of the driving system DS is exceeded. In other words, a boundary of the safety range Rs may mean a strictest safety condition assumed according to the safety model.

The safety assurance prediction block 142 illustrated in FIG. 3 sets the boundary of the safety range Rs to assure a reasonably foreseeable safety in the host vehicle 2, based on the prediction information acquired as a result of the safety assurance prediction. In other words, the safety assurance prediction can be said to be a future action prediction regarding the other road user 3 for setting the boundary of the reasonably foreseeable safety range Rs in the host vehicle 2. Here, a kinematic property that defines the boundary of the safety range Rs is at least one type that becomes a basis for driving monitoring and driving restriction/constraint in the driving restriction/constraint block 144 at the subsequent stage, among a speed, an acceleration, and a posture angle of the host vehicle 2, a separation distance from the other road user 3, and the like (FIG. 4 and FIG. 5 are examples of the acceleration), for example. Such boundary setting of the safety range Rs may be performed by the driving restriction/constraint block 144 prior to driving monitoring and restriction/constraint setting, which will be described below.

In the setting of the boundary of the safety range Rs by the safety assurance prediction block 142, a safety envelope based on a safety model between the host vehicle 2 and the other road user 3 may be assumed. Here, the safety envelope may be defined as a set of limits and conditions under which the driving system DS is designed to operate as target of a restriction/constraint or control to maintain an operation within an acceptable risk level. Such a safety envelope may be set as a physically-based margin around each road user including the host vehicle 2 and other road user 3, by a critical value or a limit value of a kinematic property that provides the boundary.

In the assuming of the safety envelope, a safety distance may be set from a profile regarding at least one type of kinematic property based on a safety model for the host vehicle 2 and the other road user 3 that are assumed to follow the driving policy. At this time, the safety distance may be assumed to define a boundary around the host vehicle 2 that secures a physically-based margin with respect to the movement of the other road user 3 predicted based on the safety model. The safety distance may be assumed taking into account a reaction time until a proper response is executed by each road user. For example, in a scene in which a lane structure such as a lane exists, a safety distance for avoiding a risk of rear-end collision and head-on collision of the host vehicle 2 in the longitudinal direction and a safety distance for avoiding a risk of side-surface collision of the host vehicle 2 in the lateral direction may be calculated. On the other hand, in a scene in which there is no lane structure, a safety distance for avoiding a risk of track collision in any direction of the host vehicle 2 may be calculated.

The safety assurance prediction block 142 may output at least one type of the prediction information acquired as described above and the boundary information of the set safety range Rs to the memory 10, as the safety assurance information. The memory 10 to which the safety assurance information is output may be mounted in the host vehicle 2, or may be installed, for example, at an external center or the like outside the host vehicle 2, depending on a type of dedicated computer constituting the driving system DS. The output safety assurance information may be temporarily stored in the memory 10, and provided to the driving restriction/constraint block 144. The output safety assurance information may be accumulated in the memory 10 by storing as evidence information. The output performance achievement information may be read from the memory 10, which serves as a temporary storage location or an accumulation location as the evidence information, and may be transmitted via the communication system 6 to, for example, an external center or the like outside the host vehicle 2.

The safety assurance information serving as evidence information may be accumulated in an unencrypted state, or may be accumulated in an encrypted or hashed state. The safety assurance information serving as the evidence information may be accumulated in the memory 10 in association with behavior information representing an actual behavior of the host vehicle 2 as past driving control information by the control block 160. The safety assurance information serving as the evidence information may be accumulated in the memory 10 in association with the performance achievement information by the performance achievement prediction block 122. The safety assurance information accumulated in this manner may be used as a lagging measure in training of a safety model that is a predictive model for the safety assurance prediction, or may be used as a leading measure in verification and validation of the safety model.

For driving control of the host vehicle 2 monitored according to the safety assurance prediction by the safety assurance prediction block 142 and the boundary of the safety range Rs, the driving restriction/constraint block 144 sets a restriction/constraint based on the monitoring. Therefore, the driving restriction/constraint block 144 performs the driving control monitoring and the restriction/constraint setting, based on the safety assurance information provided from the safety assurance prediction block 142. At this time, a necessity of the restriction/constraint setting may be monitored, depending on whether there is a violation of the safety envelope assumed in the setting of the safety range Rs by the safety assurance prediction block 142. At this time, when a safety distance is assumed as the safety envelope, it may be determined that there is no violation of the safety envelope when an actual distance between the host vehicle 2 and the other road user 3 exceeds the safety distance. On the other hand, when the actual distance between the host vehicle 2 and the other road user 3 becomes equal to or less than the safety distance, it may be determined that there is a violation of the safety envelope.

When it is determined that there is a violation of the safety envelope, the driving restriction/constraint block 144 may calculate, by simulation, a reasonable scenario for providing an appropriate action to the host vehicle 2 to take as a proper response. In the simulation of the reasonable scenario, by estimating a state transition between the host vehicle 2 and the other road user 3, an action to be taken for each transition state may be set as a restriction/constraint (which will be detailed below) for the host vehicle 2. In the action setting at this time, a limit value that limits at least one type of kinematic property given to the host vehicle 2 as a restriction/constraint on the host vehicle 2 may be calculated.

The control block 160 acquires a control command from the driving planning block 124 of the determination block 120. The control block 160 acquires restriction/constraint information from the driving restriction/constraint block 144 of the monitoring block 140. When no restriction/constraint is set by the driving restriction/constraint block 144, the control block 160 controls driving of the host vehicle 2 according to the planned control command. That is, the control block 160 implements a DDT function in which a control action is applied to the host vehicle 2. For example, examples of a use case with which a restriction/constraint is set by the driving restriction/constraint block 144 include a situation or the like in which driving is planned within the performance achievement range Rp, which falls within the boundary of the safety range Rs, as illustrated by cross hatching in FIG. 4. At this time, for example, by obtaining perception information such as vehicle motion, regarding the host vehicle 2 from the perception block 100 or via the determination block 120, the control block 160 may use the perception information for the vehicle control.

On the other hand, in a case of acquiring restriction/constraint information with a restriction/constraint set by the driving restriction/constraint block 144, the control block 160 imposes the restriction/constraint on the planned driving control of the host vehicle 2. For example, examples of a use case in which restriction/constraint is set by the driving restriction/constraint block 144 include a situation or the like in which driving is planned in a range exceeding the boundary of the safety range Rs within the performance achievement range Rp as illustrated by cross hatching in FIG. 5. Here, the restriction/constraint on the driving control may be a functional restriction or a degraded constraint. The restriction/constraint on the driving control may be a restriction/constraint different from the above restriction/constraint. In either case, the restriction/constraint on the driving control may be given by a limit on the control command. At this time, when a reasonable scenario is simulated by the driving restriction/constraint block 144, the control command may be limited according to the scenario. Further, when a limit value regarding the kinematic property of the host vehicle 2 is set, a control parameter of the actuator system 4 included in the control command may be corrected based on the limit value.

### Processing Flow

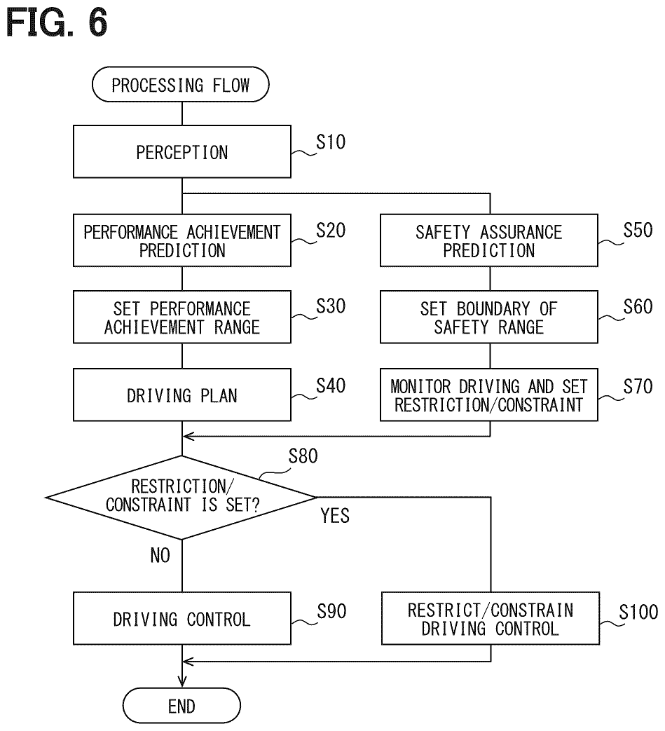

In the first embodiment, a flow of a processing method (hereinafter, referred to as a processing flow) for performing a driving process of the host vehicle 2 according to a flowchart illustrated in FIG. 6 is repeatedly executed by the cooperation of multiple blocks 100, 120, 140, and 160. In the following description, each “S” in the processing flow means multiple steps executed by multiple instructions included in a processing program.

In S10, the perception block 100 generates perception information by perceiving internal and external environments of the host vehicle 2. After the execution of S10, a performance achievement sequence of S20, S30, and S40 and a safety assurance sequence of S50, S60, and S70 are executed in parallel.

In S20 of the performance achievement sequence, the determination block 120 uses the performance achievement prediction block 122 to perform a performance achievement prediction regarding a future action of the other road user 3, as a prediction for achieving target performance in the host vehicle 2. At this time, the performance achievement prediction can be implemented based on a risk balance model. In S30 of the performance achievement sequence, the determination block 120 sets the performance achievement range Rp, in which the host vehicle 2 achieves the target performance, in accordance with the performance achievement prediction in S20 by the performance achievement prediction block 122. In S40 of the performance achievement sequence, the determination block 120 uses the driving planning block 124 to make a driving plan for the host vehicle 2 according to the performance achievement prediction in S20 and the performance achievement range Rp in S30.

On the other hand, in S50 of the safety assurance sequence, the monitoring block 140 uses the safety assurance prediction block 142 to perform a safety assurance prediction regarding the future action of the other road user 3, as a prediction for assuring a reasonably foreseeable safety in the host vehicle 2. At this time, the safety assurance prediction can be implemented based on a safety model. In S50 of the safety assurance sequence, the monitoring block 140 sets a boundary of the safety range Rs, in which a safety in the host vehicle 2 is assured, by the safety assurance prediction block 142 according to the safety assurance prediction in S50. In S70 of the safety assurance sequence, the monitoring block 140 uses the driving restriction/constraint block 144 to perform driving monitoring and restriction/constraint setting on the host vehicle 2 according to the safety assurance prediction in S50 and the boundary of the safety range Rs in S60.

In S80 which is shifted from the performance achievement sequence of S20, S30, and S40, the control block 160 determines whether a restriction/constraint is set for the host vehicle 2 through the safety assurance sequence of S50, S60, and S70. As a result, in S90 in a case where a negative determination is made, the control block 160 controls the host vehicle 2 according to the driving plan in S40 of the performance achievement sequence. On the other hand, in S100 in a case where an affirmative determination is made, the control block 160 controls the host vehicle 2 to apply the restriction/constraint set in S70 of the safety assurance sequence to the driving planned in S40 of the performance achievement sequence. With the execution completion of these steps S90 and S100, the current execution of the processing flow ends.

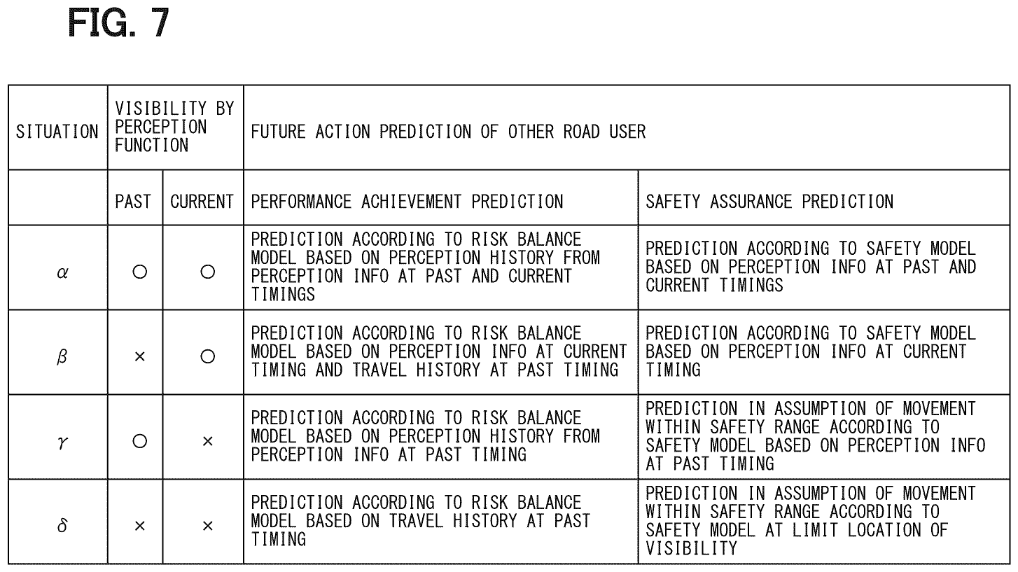

In the above processing flow, the performance achievement prediction in S20 and the safety assurance prediction in S50 may be respectively adapted for a change in perception capabilities or perception performance of the host vehicle 2. Therefore, as illustrated in FIG. 7, the performance achievement prediction in S20 and the safety assurance prediction in S50 may be executed in accordance with situations α to δ classified below.
(α) A situation in which visibility of the other road user 3 by a perception function of the driving system DS in the host vehicle 2 is secured at both a past timing and a current timing.
(β) A situation in which the visibility of the other road user 3 by the perception function in the driving system DS of the host vehicle 2 is limited at the past timing and secured at the current timing.
(γ) A situation in which the visibility of the other road user 3 by the perception function of the driving system DS in the host vehicle 2 is secured at the past timing and limited at the current timing.
(δ) A situation in which the visibility of the other road user 3 by the perception function of the driving system DS in the host vehicle 2 is limited at both the past timing and the current timing.

In the classification description below, the past timing may correspond to an execution timing of each prediction in S20 and S50 of at least one past execution prior to the current execution of the processing flow. On the other hand, the current timing may correspond to an execution timing of each prediction in S20 and S50 in the current execution of the processing flow.

In the classification description, the situation may be classified as a situation in which the visibility of the other road user 3 by the perception function is secured regardless of a reliability defined by using, for example, detection accuracy of the sensor system 5, and a situation in which the securing is not possible with a limit. The situation may be classified as a situation in which the visibility is secured when the reliability defined by using, for example, the detection accuracy is equal to or more than or exceeds a set level, and a situation in which the visibility is limited when the reliability is below or less than the set level.

In the performance achievement prediction in S20 in a case of the situation α, a future action prediction of the other road user 3 according to a risk balance model may be implemented, based on a perception history that can be interpreted from perception information obtained by the perception function with which the visibility is secured at both the past and current timings. On the other hand, in the safety assurance prediction in S50 in a case of the situation α, the future action prediction of the other road user 3 within the safety range Rs according to a safety model may be implemented, based on perception information such as a position and a speed by the perception function with which the visibility is secured at both the past and current timings.

In the performance achievement prediction in S20 in a case of the situation β, the future action prediction of the other road user 3 according to a risk balance model may be implemented, based on perception information obtained by the perception function with which the visibility is secured at the current timing and a travel history regarding the other road user 3 at the past timing when the visibility of the perception function is limited. Here, the travel history at the past timing may be perception information on a traffic flow, which is acquired from the other road user 3 or an external center at the current timing through V2X communication via the communication system 6. On the other hand, in the safety assurance prediction in S50 in a case of the situation β, the future action prediction of the other road user 3 within the safety range Rs according to a safety model may be implemented, based on perception information such as, for example, position and a speed by the perception function with which the visibility is secured at the current timing.

In the performance achievement prediction in S20 in a case of the situation γ, the future action prediction of the other road user 3 according to a risk balance model may be implemented, based on a history information on a perception history, which can be interpreted from perception information obtained by the perception function with which the visibility is secured at the past timing. On the other hand, in the safety assurance prediction in S50 in a case of the situation γ, the future action prediction of the other road user 3 who is assumed to move within the safety range Rs according to a safety model may be implemented, based on perception information such as, for example, position and a speed by the perception function with which the visibility is secured at the past timing.

In the performance achievement prediction in S20 in a case of the situation δ, the future action prediction of the other road user 3 according to a risk balance model may be implemented, based on a travel history regarding the other road user 3 at the past timing when the visibility of the perception function is limited. Here, the travel history at the past timing may be perception information on a traffic flow, which is acquired at the current timing through V2X communication, in the same manner as the situation β. On the other hand, the safety assurance prediction in S50 in a case of the situation δ may be a future action prediction of the other road user 3 who is assumed to move within the safety range Rs according to a safety model at a place at which the visibility of the perception function is limited at both the past and current timings, such as a blind spot from the host vehicle 2, for example.

As described so far, in the host vehicle 2 of the first embodiment, a driving plan is executed according to a performance achievement prediction obtained by predicting a future action of the other road user 3 in an external environment of the host vehicle 2, as a prediction for achieving target performance. Therefore, in the host vehicle 2 of the first embodiment, driving monitoring is executed according to a safety assurance prediction obtained by predicting the future action of the other road user 3 independently of the performance achievement prediction, as a prediction for assuring a reasonably foreseeable safety. According to this, driving of the host vehicle 2 that is planned according to the performance achievement prediction is monitored according to the safety assurance prediction, so that it becomes possible to achieve a balance between performance and a safety for the driving.

### Second Embodiment

A second embodiment is a modification of the first embodiment.

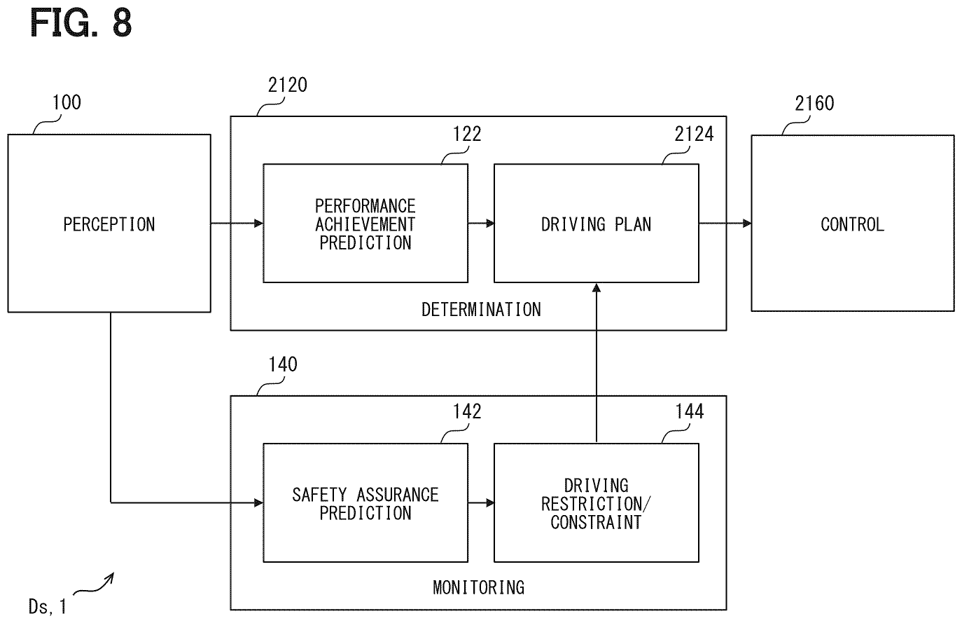

As illustrated in FIG. 8, in a functional architecture of the second embodiment, the function of acquiring restriction/constraint information from the driving restriction/constraint block 144 of the monitoring block 140 is implemented by a driving planning block 2124 of a determination block 2120, instead of a control block 2160. Therefore, the driving planning block 2124 in a case where no restriction/constraint is set by the driving restriction/constraint block 144 plans driving of the host vehicle 2 according to the first embodiment. On the other hand, in a case where a restriction/constraint is set by the driving restriction/constraint block 144 and restriction/constraint information is acquired, at a stage of planning driving of the host vehicle 2 according to the first embodiment, the driving planning block 2124 imposes the restriction/constraint on the driving plan. In either case, the control block 2160 executes the driving control of the host vehicle 2 planned by the driving planning block 2124.

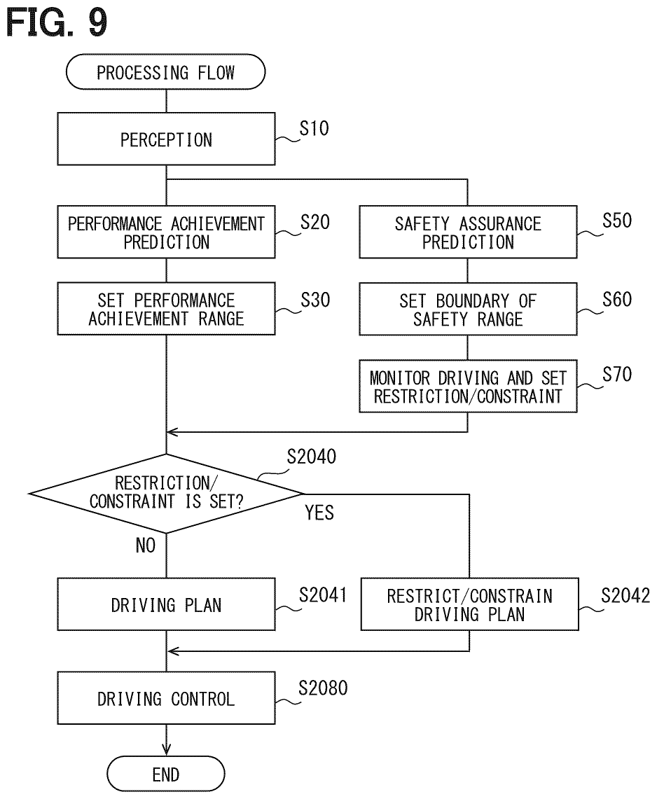

As illustrated in FIG. 9, in a processing flow of the second embodiment, in S2040 following S30 in the performance achievement sequence, the determination block 2120 causes the driving planning block 2124 to determine whether a restriction/constraint is set for the host vehicle 2 through the safety assurance sequence of S50, S60, and S70. When a negative determination is made, in S2041 of the performance achievement sequence, the determination block 2120 causes the driving planning block 2124 to make a driving plan for the host vehicle 2 according to the performance achievement prediction in S20 and the performance achievement range Rp in S30. On the other hand, when an affirmative determination is made, in S2042 of the performance achievement sequence, the determination block 2120 causes the driving planning block 2124 to make a driving plan such that the restriction/constraint in S70 of the safety assurance sequence is given to the driving of the host vehicle 2 in accordance with the performance achievement prediction in S20 and the performance achievement range Rp in S30. In S2080 which is shifted when any of the execution of these S2041 and S2042 is completed, the control block 2160 controls the host vehicle 2 according to the driving plan of the step before the shifting among S2041 and S2042. As described above, upon completion of the execution of S2080, the current execution of the processing flow ends.

Also in the second embodiment described so far, by following the principle described in the first embodiment, it is possible to achieve a balance between performance and a safety in driving of the host vehicle 2.

### Third Embodiment

A third embodiment is a modification of the second embodiment.

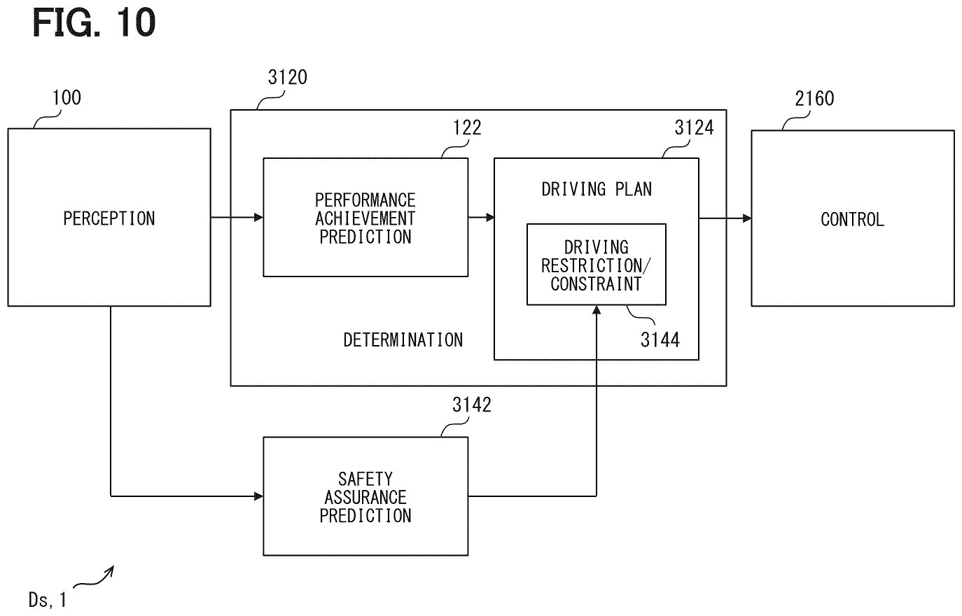

As illustrated in FIG. 10, in a functional architecture of a third embodiment, a monitoring function and a restriction/constraint setting function by a driving restriction/constraint block 3144 are implemented as a part of a function of a driving planning block 3124 of a determination block 3120. Therefore, the monitoring function and the restriction/constraint setting function by the driving restriction/constraint block 3144 may be called for each of multiple applications or in common by the multiple applications on software while the planning function by the driving planning block 3124 is being executed. In this case, a safety assurance prediction function by a safety assurance prediction block 3142 may be independent not only from a performance achievement prediction by the performance achievement prediction block 122, but also from a driving plan by the driving planning block 3124 and driving monitoring by the driving restriction/constraint block 3144.

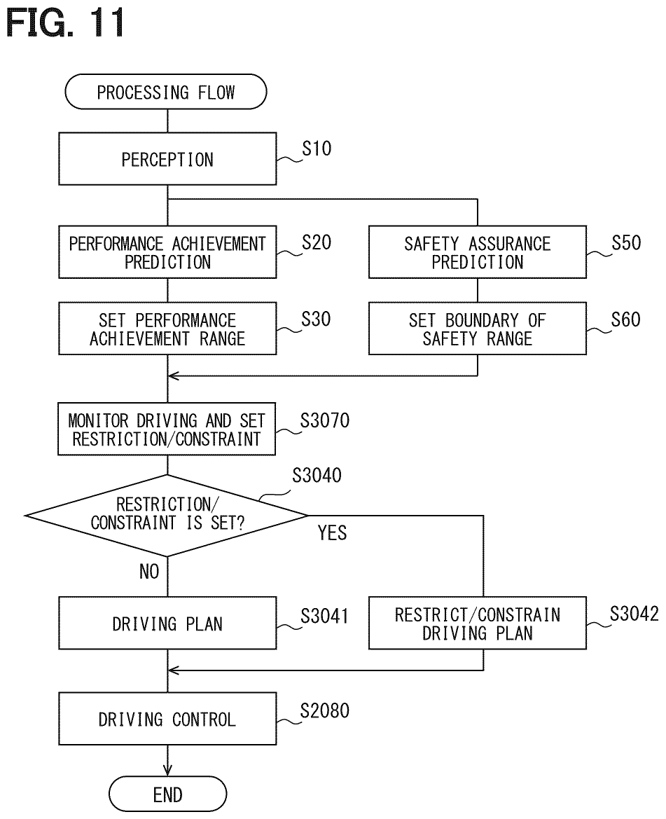

As illustrated in FIG. 11, in a processing flow of the third embodiment, in S3070 which is a common step of a performance achievement sequence and a safety assurance sequence, the determination block 3120 causes the driving restriction/constraint block 3144 to perform the driving monitoring and the restriction/constraint setting of the host vehicle 2 according to the safety assurance prediction in S50 and the boundary of the safety range Rs in S60. Therefore, in S3040 following S3070 in the performance achievement sequence, the determination block 3120 causes the driving planning block 3124 to determine whether a restriction/constraint is set for the host vehicle 2 through the safety assurance sequence of S50, S60, and S3070. When a negative determination is made, in S3041 of the performance achievement sequence, the determination block 3120 causes the driving planning block 3124 to make a driving plan for the host vehicle 2 according to the performance achievement prediction in S20 and the performance achievement range Rp in S30. On the other hand, when an affirmative determination is made, in S3042 of the performance achievement sequence, the determination block 3120 causes the driving planning block 3124 to make a driving plan such that the restriction/constraint in S3070 is given to the driving of the host vehicle 2 in accordance with the performance achievement prediction in S20 and the performance achievement range Rp in S30. When the execution of either of S3041 and S3042 is completed, the processing flow is shifted to S2080.

Also in the third embodiment described so far, by following the principle described in the first embodiment, it is possible to achieve a balance between performance and a safety in driving of the host vehicle 2.

### Other Embodiments

Although multiple embodiments are described above, the present disclosure is not construed as being limited to these embodiments, and can be applied to various embodiments and combinations within a scope that does not depart from the gist of the present disclosure.

In another modification, a dedicated computer constituting the processing system 1 may include at least one of a digital circuit and an analog circuit, as a processor. Here, the digital circuit is at least one type of, for example, an application specific integrated circuit (ASIC), a field programmable gate array (FPGA), a system on a chip (SOC), a programmable gate array (PGA), a complex programmable logic device (CPLD), and the like. Such a digital circuit may also include a memory in which a program is stored.

In still another modification, a driver who is an operator among occupants of the host vehicle 2 may be replaced by a remote operator or a remote driver who remotely operates the host vehicle 2 at an external center. In still another modification, a host moving object to which the driving system DS and the processing system 1 are applied may be an autonomous traveling robot capable of transporting parcels, collecting information, and the like by autonomous traveling or remote traveling. In addition to the above, the processing system 1 according to each of the embodiments and the modifications may be executed in a form of a processing circuit (for example, processing ECU or the like) or a semiconductor device (for example, semiconductor chip or the like), as a processing device configured to be mounted on a host moving object and including at least one processor 12 and one memory 10.

### Description of terms

Terms related to the present disclosure will be described below. This description is included in the embodiments of the present disclosure.

A road user may be anyone who uses a road including sidewalk and other adjacent spaces. The road user may be a user on an active road or a road adjacent to the active road, for the purpose of moving from one location to another location.

An other road user may be a vulnerable road user and a non-vulnerable road user with no role in an autonomous driving subject vehicle.

A dynamic driving task (DDT) may be real-time operational and tactical functions required to operate a vehicle in traffic.

A behavior of a subject vehicle may be obtained by interpreting a vehicle motion based on traffic conditions. Here, the vehicle motion may be a vehicle state and its dynamics in terms of physical quantities (for example, a speed, an acceleration, and the like).

A scenario may be a description of the temporal relationship between several scenes, with goals and values within a specified situation in a sequence of scenes influenced by actions and events. The scenario may be a depiction of consecutive time series of activities integrating the subject vehicle, all its external environment and their interactions in the process of performing a certain driving task.

A situation is a factor that can affect a behavior of a system, and may include traffic conditions, weather, and the behavior of the subject vehicle.

A triggering condition may be a specific condition of a scenario that serves as an initiator for a subsequent system reaction contributing to either a hazardous behavior or an inability to prevent or detect and mitigate a reasonably foreseeable indirect misuse.

An operational design domain (ODD) may be a specific condition under which a given (automated) driving system is designed to function. The operational design domain may be an operating condition under which a given (automated) driving system or feature is specifically designed to function, including, but not limited to, environmental, geographical, and time-of-day restrictions, and/or the requisite presence or absence of a necessity of certain traffic or roadway characteristics.

An automated driving system may be a set of hardware and software that can execute the entire DDT on a continuous basis, regardless of whether it is limited to a specific ODD.

Safety of the intended functionality (SOTIF) may be the absence of unreasonable risk due to inadequacy of the intended functionality or its implementation.

A driving policy may be a strategy and a rule that define a control action at a vehicle level.

A vehicle level SOTIF strategy (VLSS) may be the set of vehicle-level requirements for the intended functionality (3.14) used to support design, verification and validation activities to achieve the SOTIF.

An unreasonable risk may be a risk judged to be unacceptable in a certain context according to valid societal moral concepts.

Safety-related models may be representation of safety-related aspects of the driving action based on assumptions about reasonably foreseeable behaviors of other road users. The safety-related models may be an on-board or off-board safety checker device or safety analysis device, a mathematical model, a set of more conceptual rules, a set of scenario-based behaviors, or a combination thereof.

A safety envelope may be a set of limits and conditions under which the (automated) driving system is designed to operate as a target of a restriction/constraint or control in order to maintain operation within an acceptable level of risk. The safety envelope may be a general concept that can be used to accommodate all the principles to which the driving policy can adhere, and according to this concept, the subject vehicle which operates by the (automated) driving system can have one or multiple boundaries around it.

A proper response may be an action that resolves an hazardous situation when the other road user is acting in accordance with assumptions on a reasonably foreseeable behavior.

A safe state may be a reasonably safe operation mode.

A performance limitation may be a design limit value at which the system can achieve objectives, and can be set for multiple parameters.

A minimal risk condition (MRC) may be a vehicle state in order to reduce the risk, when a given trip cannot be completed. The minimal risk condition may be a condition to which a user or an (automated) driving system may bring a vehicle after performing the minimal risk manoeuvre in order to reduce the risk of a crash when a given trip cannot be completed.

A minimal risk manoeuvre (MRM) may be (automated) driving system's capability of transitioning the vehicle between nominal and minimal risk conditions.

A DDT fallback may be a response by a driver or the (automated) driving system to either perform the DDT or transition to the MRC after the occurrence of a failure(s) or detection of a functional insufficiency or upon detection of a potentially hazardous behavior.

An emergency manoeuvre may be a manoeuvre performed by a vehicle in case of an event in which the vehicle is at imminent collision risk and has the purpose of avoiding or mitigating a collision.

A takeover may be a transfer of driving tasks between the (automated) driving system and the driver.

The driver may be a user who performs in real-time part or all of the DDT and/or DDT fallback for a particular vehicle. A remote driver may be a driver who is not seated in a position to manually operate in-vehicle braking, accelerating, steering, and transmission gear selection input devices but is able to operate the vehicle.

An operator may be a designated person, appropriately trained and authorized, to operate a car. The remote operator may be an operator who is not seated in a position to manually operate in-vehicle braking, accelerating, steering, and transmission gear selection input devices but is able to operate the vehicle with or without direct vision.

V2X may be a technology that augments a vehicle to exchange additional information with infrastructure, other vehicles, and other road users.

What is claimed is:

1. A processing method executed by a processor for performing a processing related to a driving of a host moving object, the processing method comprising:
a performance achievement prediction that predicts a future action of an other road user in an external environment of the host moving object as a prediction for achieving a target performance of the host moving object;
a driving plan that plans the driving of the host moving object according to the performance achievement prediction;
a safety assurance prediction that predicts, independently of the performance achievement prediction, the future action of the other road user in the external environment as a prediction for assuring a reasonably foreseeable safety of the host moving object; and
a driving monitoring that monitors the driving of the host moving object according to the safety assurance prediction.

2. The processing method according to claim 1, wherein,
in the performance achievement prediction, the future action of the other road user is predicted as a prediction for setting a performance achievement range that achieves the target performance of the host moving object.

3. The processing method according to claim 1, wherein,
in the performance achievement prediction, the future action of the other road user is predicted as a prediction for avoiding a risk of an unreasonable other responsibility on the host moving object.

4. The processing method according to claim 1, wherein,
in the performance achievement prediction, the future action of the other road user is predicted as a prediction based on a statistical model obtained by modeling a positive risk balance.

5. The processing method according to claim 4, wherein,
in the performance achievement prediction, the future action of the other road user is predicted based on the statistical model corresponding to perception information acquired at a timing when a visibility of the other road user is secured by a perception function of a driving system, which is mounted on the host moving object.

6. The processing method according to claim 5, wherein,
in the performance achievement prediction, when the visibility of the other road user by the perception function of the driving system of the host moving object is limited at a past timing, the future action of the other road user is predicted based on a travel history of the other road user at the past timing, and
the travel history of the other road user at the past timing is acquired at a current timing through V2X communication.

7. The processing method according to claim 1, further comprising:
outputting prediction information acquired by the performance achievement prediction.

8. The processing method according to claim 1, wherein,
in the safety assurance prediction, the future action of the other road user is predicted as a prediction for setting a boundary of a reasonably foreseeable safety range of the host moving object.

9. The processing method according to claim 1, wherein,
in the safety assurance prediction, the future action of the other road user is predicted as a prediction for avoiding a risk of unreasonable self-responsibility of the host moving object.

10. The processing method according to claim 1, wherein,
in the safety assurance prediction, the future action of the other road user is predicted as a prediction based on a safety model obtained by modeling safety of an intended functionality.

11. The processing method according to claim 10, wherein,
in the safety assurance prediction, the future action of the other road user is predicted based on the safety model corresponding to perception information acquired at a timing when a visibility of the other road user is secured by a perception function of a driving system, which is mounted on the host moving object.

12. The processing method according to claim 11, wherein,
in the safety assurance prediction, when the visibility of the other road user by the perception function of the driving system of the host moving object is limited at a current timing, the future action of the other road user is predicted under an assumption that the other road user moves within a safety range set in the safety model.

13. The processing method according to claim 1, further comprising
outputting prediction information acquired by the safety assurance prediction.

14. The processing method according to claim 1, wherein,
in the driving monitoring, a restriction or constraint on the driving of the host moving object is set according to the safety assurance prediction.

15. A driving system comprising
a computer-readable non-transitory storage medium; and
a processor performing a processing related to a driving of a host moving object,
wherein
the processor, by executing a program stored in the computer-readable non-transitory storage, is configured to execute:
a performance achievement prediction that predicts a future action of an other road user in an external environment of the host moving object as a prediction for achieving a target performance of the host moving object;
a driving plan that plans the driving of the host moving object according to the performance achievement prediction;
a safety assurance prediction that predicts, independently of the performance achievement prediction, the future action of the other road user in the external environment as a prediction for assuring a reasonably foreseeable safety of the host moving object; and
a driving monitoring that monitors the driving of the host moving object according to the safety assurance prediction.

16. A processing device mounted on a host moving object and performing a processing related to a driving of the host moving object, the processing device comprising
a computer-readable non-transitory storage medium; and
a processor, by executing a program stored in the computer-readable non-transitory storage, configured to execute:
a performance achievement prediction that predicts a future action of an other road user in an external environment of the host moving object as a prediction for achieving a target performance of the host moving object;
a driving plan that plans the driving of the host moving object according to the performance achievement prediction;
a safety assurance prediction that predicts, independently of the performance achievement prediction, the future action of the other road user in the external environment as a prediction for assuring a reasonably foreseeable safety of the host moving object; and
a driving monitoring that monitors the driving of the host moving object according to the safety assurance prediction.

17. A processing program product stored in a computer-readable non-transitory storage medium and comprising instructions to be executed by a processor to perform a processing related to a driving of a host moving object, the instructions causing the processor to execute:
a performance achievement prediction that predicts a future action of an other road user in an external environment of the host moving object as a prediction for achieving a target performance of the host moving object;
a driving plan that plans the driving of the host moving object according to the performance achievement prediction;
a safety assurance prediction that predicts, independently of the performance achievement prediction, the future action of the other road user in the external environment as a prediction for assuring a reasonably foreseeable safety of the host moving object; and
a driving monitoring that monitors the driving of the host moving object according to the safety assurance prediction.
